(19) United States
(12) Patent Application Publication
(10) Pub. No.: US 2015/0029582 A1
(43) Pub. Date: Jan. 29, 2015

(54) INFRARED FILTER

(71) Applicant: LARGAN PRECISION CO., LTD., Taichung City (TW)

(72) Inventors: Chien-Pang CHANG, Taichung City (TW); Kuo-Chiang CHU, Taichung City (TW)

(73) Assignee: LARGAN PRECISION CO., LTD., Taichung City (TW)

(21) Appl. No.: 13/974,063

(22) Filed: Aug. 23, 2013

(30) Foreign Application Priority Data
Jul. 23, 2013 (TW) 102126301

(51) Int. Cl. G02B 5/20

(52) U.S. Cl. CPC G02B 5/208
USPC 359/360

(57) ABSTRACT

An infrared filter includes a transparent substrate, and an infrared-filtering multilayer film. The infrared-filtering multilayer film is coated on the transparent substrate, and the infrared-filtering multilayer film includes a plurality of first dielectric layers and a plurality of silver layers. The first dielectric layers and the silver layers are alternately stacked, wherein the first dielectric layers are made of nitride.

### RELATED APPLICATIONS

This application claims priority to Taiwan Application Serial Number 102126301, filed Jul. 23, 2013, which is incorporated by reference herein in its entirety.

### BACKGROUND

1. Technical Field

The present disclosure relates to a filter. More particularly, the present disclosure relates to a filter for filtering infrared light.

2. Description of Related Art

Conventional optical systems constitute a set of lens elements and an image sensor, wherein the set of lens elements is disposed at an object side of the optical system and the image sensor is disposed at an image side of the optical system. Since the image sensor has high sensitivity to the infrared light, the infrared light thus may washout the color response in the visible spectrum and thus may distort the image color reproduction. Conventional infrared filters are mostly recognized as interference type filters and absorption type filters. The interference type filter filters out the infrared light by applying alternate film layers of high refractive index (for example, TiO₂, Ta₂O₅ or Nb₂O₅) and low refractive index materials (for example, SiO₂ or MgF₂). The absorption type filter typically uses a blue glass to block the infrared light since the materials inside the blue glass absorb the infrared light.

In recent years, as the optical systems of the electronic products have gradually evolved toward compact size and wide viewing angle, the total track length of the optical systems has to be reduced and the chief ray angle also has to be large. However, as the absorption type of infrared filter is relatively expensive and it has issues with environment stability. It is also not favorable for being applied to compact optical systems as it is relatively thick. Moreover, the interference type of infrared filter tends to produce color shift in a peripheral region of an image as the chief ray angle becomes larger. Since it generally requires certain layers to be coated; therefore, it is not favorable for being applied to compact optical systems. Especially, when it is deposited a multilayer with a high layer count, it tends to produce warpage due to uneven internal stress. It also tends to produce obvious image defects due to particle pollution by depositing high-layer-count coatings.

### SUMMARY

According to one aspect of the present disclosure, an infrared filter includes a transparent substrate, and an infrared-filtering multilayer film. The infrared-filtering multilayer film is coated on the transparent substrate, and the infrared-filtering multilayer film includes a plurality of first dielectric layers and a plurality of silver layers. The first dielectric layers and the silver layers are alternately stacked, wherein the first dielectric layers are made of nitride. When a total number of layers in the infrared-filtering multilayer film is TL, a total thickness of the infrared-filtering multilayer film is TT, and a total number of the silver layers is AgL, the following conditions are satisfied:

6≦TL≦42;

100 nm≦TT≦4000 nm; and

3≦AgL≦21.

### BRIEF DESCRIPTION OF THE DRAWINGS

The disclosure can be more fully understood by reading the following detailed description of the embodiment, with reference made to the accompanying drawings as follows:

FIG. 1 is a schematic view of an infrared filter according to the 1st embodiment of the present disclosure:

FIG. 2 is a schematic view of an infrared filter according to the 2nd embodiment of the present disclosure;

FIG. 3 is a schematic view of an infrared filter according to the 3rd embodiment of the present disclosure;

FIG. 4 is a schematic view of an infrared filter according to the 4th embodiment of the present disclosure;

FIG. 5 is a schematic view of an infrared filter according to the th embodiment of the present disclosure;

FIG. 6 is a schematic view of an infrared filter according to the 6th embodiment of the present disclosure;

FIG. 7 is a schematic view of an infrared filter according to the 7th embodiment of the present disclosure;

FIG. 8 shows transmittance and relative responsivity spectrum of an infrared filter according to the 1st embodiment of the present disclosure;

FIG. 9 shows transmittance and relative responsivity spectrum of an

FIG. 10 shows transmittance and relative responsivity spectrum of an infrared filter according to the 3rd embodiment of the present disclosure;

FIG. 11 shows transmittance and relative responsivity spectrum of another infrared filter according to the 3th embodiment of the present disclosure;

FIG. 12 shows transmittance and relative responsivity spectrum of still another infrared filter according to the 3th embodiment of the present disclosure;

FIG. 13 shows transmittance and relative responsivity spectrum of an infrared filter according to the 4th embodiment of the present disclosure;

FIG. 14 shows transmittance and relative responsivity spectrum of an infrared filter according to the 5th embodiment of the present disclosure;

FIG. 15 shows transmittance and relative responsivity spectrum of an infrared′ filter according to the 6th embodiment of the present disclosure;

FIG. 16 shows transmittance and relative responsivity spectrum of an infrared filter according to the 7th embodiment of the present disclosure; and

FIG. 17 shows transmittance and relative responsivity spectrum of an infrared filter according to the comparative example

### DETAILED DESCRIPTION

An infrared filter includes a transparent substrate, and an infrared-filtering multilayer film. The infrared-filtering multilayer film is coated on the transparent substrate, and the infrared-filtering multilayer film includes a plurality of first dielectric layers and a plurality of silver layers. The first dielectric layers and the silver layers are alternately stacked, wherein the first dielectric layers are made of nitride, such as, but are not limited to, SiN, AlN, or GaN. When a total number of layers in the infrared-filtering multilayer film is TL, a total thickness of the infrared-filtering multilayer film is TT, and a total number of the silver layers is AgL, the following conditions are satisfied:

6≦TL≦42;

100 nm≦TT≦4000 nm; and

3≦AgL≦21.

The first dielectric layers and the silver layers are alternately stacked, wherein the first dielectric layers are made of nitride. Accordingly, it is favorable for preventing the silver layers from reducing reflectivity due to oxidation. Moreover, the infrared filter is favorable for effectively reducing the red light loss so as to reduce the color shift.

When the total number of layers in the infrared-filtering multilayer film is TL, the following condition is satisfied: 6≦TL≦42. Since the total number of layers in the infrared-filtering multilayer film is less, it is favorable for reducing the particle pollution so as to improve the image defect.

When the total thickness of the infrared-filtering multilayer film is TT, the following condition is satisfied: 100 nm≦TT≦4000 nm. Since the total thickness of the infrared-filtering multilayer film is relatively thin, it is favorable for balancing the internal stress of the infrared filter as to avoid warpage. Preferably, the following condition is satisfied: 100 nm≦TT≦2000 nm.

When the total number of the silver layers is AgL, the following condition is satisfied: 3≦AgL≦21. It is favorable for controlling the cost for coating layers and further correcting the color shift.

When the first dielectric layers are made of silicon nitride (SiₓN_{y}), aluminum nitride (AlN), or gallium nitride (GaN); the total number of the first dielectric layers is DLA, the following condition is satisfied: 3≦DLA. Therefore, it is favorable for preventing the silver layers from reducing reflectivity due to oxidation.

When the infrared-filtering multilayer film can further include at least one second dielectric layer, wherein at least one of the first dielectric layers is coated between the second dielectric layer and one of the silver layers, and the second dielectric layer can be made of metal oxide, the total number of the first dielectric layers is DLA, a total number of the second dielectric layer is DLB, the following conditions are satisfied: 5≦DLA; and 1≦DLB. Therefore, it is favorable for reducing the coating cost and enhancing the abrasion resistance and hardness.

According to the infrared filter of the present disclosure, the transparent substrate can be made of plastic or glass material. When the transparent substrate is made of plastic material, the manufacturing cost thereof can be reduced. Moreover, the infrared-filtering multilayer film can be coated on the plastic lens elements with refractive power so as to further filter out infrared light and correct color shift.

When a decay rate of the transmittance responsivity value through the infrared filter between 554 nm and 700 nm is D, the following condition is satisfied: 1%≦D≦30%, Therefore, it is favorable for effectively correcting the color shift. Preferably, the following condition is satisfied: 1%≦D≦20%.

According to the infrared filter of the present disclosure, the transmittance responsivity value (TR) is defined as the sum of transmittance (X) multiplied by relative responsivity of the image sensor (Y) under a reference wavelength (between m and n) with an interval of 1 nm, and the decay rate (D) is defined as the decrease in TR at two different chief ray angles through the infrared filter under a reference wavelength, the equations are expressed as follows:

$$TR = {\sum }_{i = m}^{n} {X}_{i} {Y}_{i} ,$$

where,

m is the starting wavelength;

n is the ending wavelength;

both of m and n are integer;

X is transmittance; and

Y is relative responsivity of the image sensor.

$$D = ( 1 - \frac{{TR}_{2}}{{TR}_{1}} ) \times 100 \% ,$$

where,

D is the decay rate;

TR₁ is the transmittance responsivity when the chief ray angle is at 0 degrees;

TR₂ is the transmittance responsivity when the chief ray angle is at 40 degrees;

It will be apparent to those skilled in the art that the aforementioned decay rate is the decay rate of the infrared filter of the present disclosure.

According to the infrared filter of the present disclosure, at least one of the first dielectric layers is coated between the second dielectric layer and one of the silver layers, that is, the second dielectric layer is not adjacent to the silver layers. More specifically, the second dielectric layer can be coated between two first dielectric layers, the transparent substrate and the first dielectric layer, or air and the first dielectric layer.

On the other hand, when the total number of the second dielectric layer is greater than 1, each of the second dielectric layers may be made of different materials. Each of the second dielectric layers may be stacked together as long as the second dielectric layer is not adjacent to the silver layers. Furthermore, each layer of the infrared-filtering multilayer film coated on the transparent substrate may be coated using different techniques such as evaporation or sputtering.

According to the above description of the present disclosure, the following 1st-7th specific embodiments are provided for further explanation.

### 1st Embodiment

FIG. 1 is a schematic view of an infrared filter 100 according to the 1st embodiment of the present disclosure. In FIG. 1, the infrared filter 100 includes a transparent substrate 110, and an infrared-filtering multilayer film 120. The infrared-filtering multilayer film 120 includes three first dielectric layers 121 and three silver layers 122, wherein the three first dielectric layers 121 and the three silver layers 122 are alternately stacked, and one of the silver layers 122 of the infrared-filtering multilayer film 120 is directly coated on the transparent substrate 110.

In the 1st embodiment, the first dielectric layers 121 are made of SiN (silicon mononitride), but are not limited thereto. The first dielectric layers 121 may also be made of AlN, GaN, or other silicon nitrides with varying silicon oxidation states (SiₓN_{y}).

In FIG. 1, each layer of the infrared-filtering multilayer file 120 is numbered 1 to 6 in ascending order, starting from the layer closest to the transparent substrate 110 to the layer closest to air. The material and the thickness of each layer in the infrared-filtering multilayer film 120 are shown in Table 1. Moreover, the decay rate and the transmittance responsivity value of the infrared filter 100 at two different chief ray angles (0° and 40°) are shown in Table 2.

TABLE 1

| No. | Material | Thickness (nm) | Type of layer | |
|---|---|---|---|---|
| 6 | SiN | 36.4 | first dielectric layer | 121 |
| 5 | Ag | 19.6 | silver layer | 122 |
| 4 | SiN | 74.1 | first dielectric layer | 121 |
| 3 | Ag | 17.8 | silver layer | 122 |
| 2 | SiN | 63.4 | first dielectric layer | 121 |
| 1 | Ag | 8.9 | silver layer | 122 |

TABLE 2

| First dielectric | Chief Ray | Blue | Green | Red |
|---|---|---|---|---|
| layer 121 | Angles (deg.) | Light | Light | Light |
| | | Transmittance Responsivity Value | | |
| SiN | 0 | 81.28 | 91.23 | 63.10 |
| | 40 | 80.09 | 88.53 | 52.82 |

| Decay Rate (%) | | |
|---|---|---|
| 1.46 | 2.95 | 16.30 |

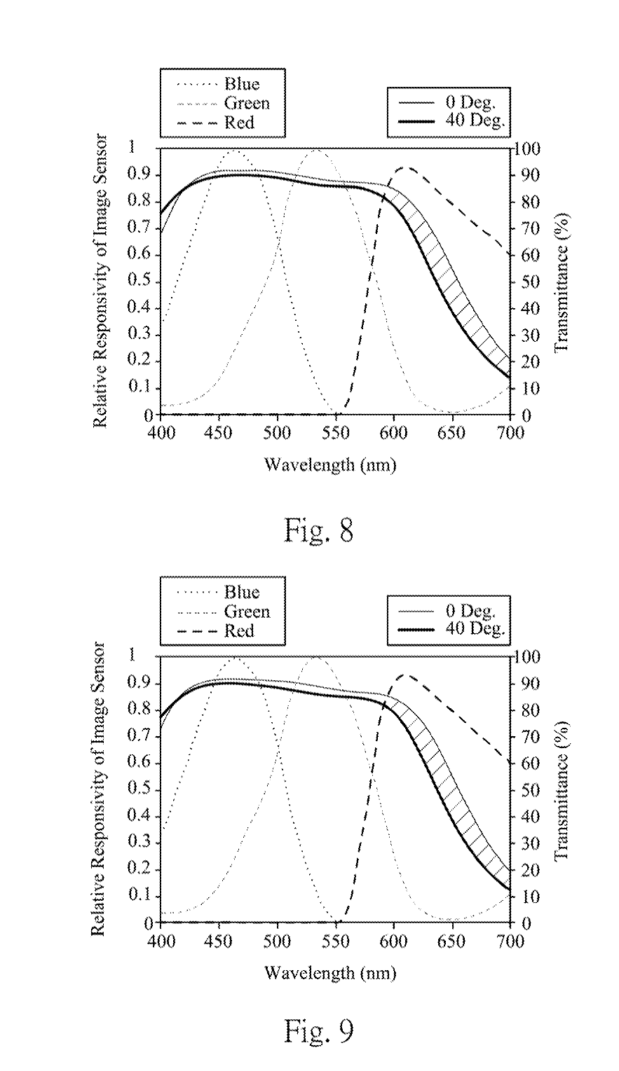

In Table 1, a total thickness of the infrared-filtering multilayer film 120 of the infrared filter 100 is 220.2 nm. FIG. 8 together shows a transmittance and relative responsivity spectrum of the infrared filter 100, and the hatched region represents the difference in the transmittance responsivity values (within the wavelength range of 554 nm to 700 nm) between chief ray angles of 0 degrees and 40 degrees.

### 2nd Embodiment

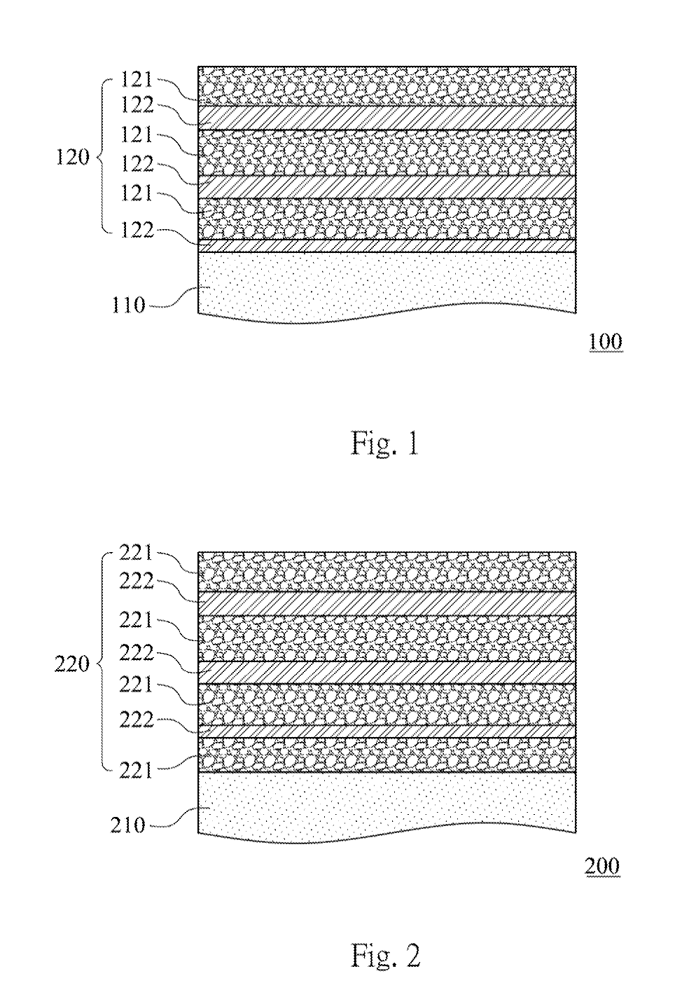

FIG. 2 is a schematic view of an infrared filter 200 according to the 2nd embodiment of the present disclosure. In FIG. 2, the infrared filter 200 includes a transparent substrate 210, and an infrared-filtering multilayer film 220. The infrared-filtering multilayer film 220 includes four first dielectric layers 221 and three silver layers 222, wherein the four first dielectric layers 221 and the three silver layers 222 are alternately stacked, and one of the first dielectric layers 221 of the infrared-filtering multilayer film 220 is directly coated on the transparent substrate 210.

In the 2nd embodiment, the first dielectric layers 221 are made of SiN (silicon mononitride), but are not limited thereto. The first dielectric layers 221 may also be made of AIN, GaN, or other silicon nitrides with varying silicon oxidation states (SiₓN_{y}).

In FIG. 2, each layer of the infrared-filtering multilayer film 220 is numbered 1 to 7 in ascending order, starting from the layer closest to the transparent substrate 210 to the layer closest to air. The material and the thickness of each layer in the infrared-filtering multilayer film 220 are shown in Table 3. Moreover, the decay rate and the transmittance responsivity value of the infrared filter 200 at two different chief ray angles (0° and 40°) are shown in Table 4.

TABLE 3

| No. | Material | Thickness (nm) | Type of layer | |
|---|---|---|---|---|
| 7 | SiN | 36.5 | first dielectric layer | 221 |
| 6 | Ag | 19.3 | silver layer | 222 |
| 5 | SiN | 73.9 | first dielectric layer | 221 |
| 4 | Ag | 18.2 | silver layer | 222 |
| 3 | SiN | 71.9 | first dielectric layer | 221 |
| 2 | Ag | 14.0 | silver layer | 222 |
| 1 | SiN | 34.2 | first dielectric layer | 221 |

TABLE 4

| First dielectric | Chief Ray | Blue | Green | Red |
|---|---|---|---|---|
| layer 221 | Angles (deg.) | Light | Light | Light |
| | | Transmittance Responsivity Value | | |
| SiN | 0 | 81.73 | 91.15 | 63.08 |
| | 40 | 80.30 | 88.15 | 52.81 |

| Decay Rate (%) | | |
|---|---|---|
| 1.75 | 3.29 | 16.28 |

In Table 3, a total thickness of the infrared-filtering multilayer film 220 of the infrared filter 200 is 268 nm. FIG. 9 together shows a transmittance and relative responsivity spectrum of the infrared filter 200 and the hatched region represents the difference in the transmittance responsivity values (within the wavelength range of 554 nm to 700 nm) between chief ray angles of 0 degrees and 40 degrees.

### 3rd Embodiment

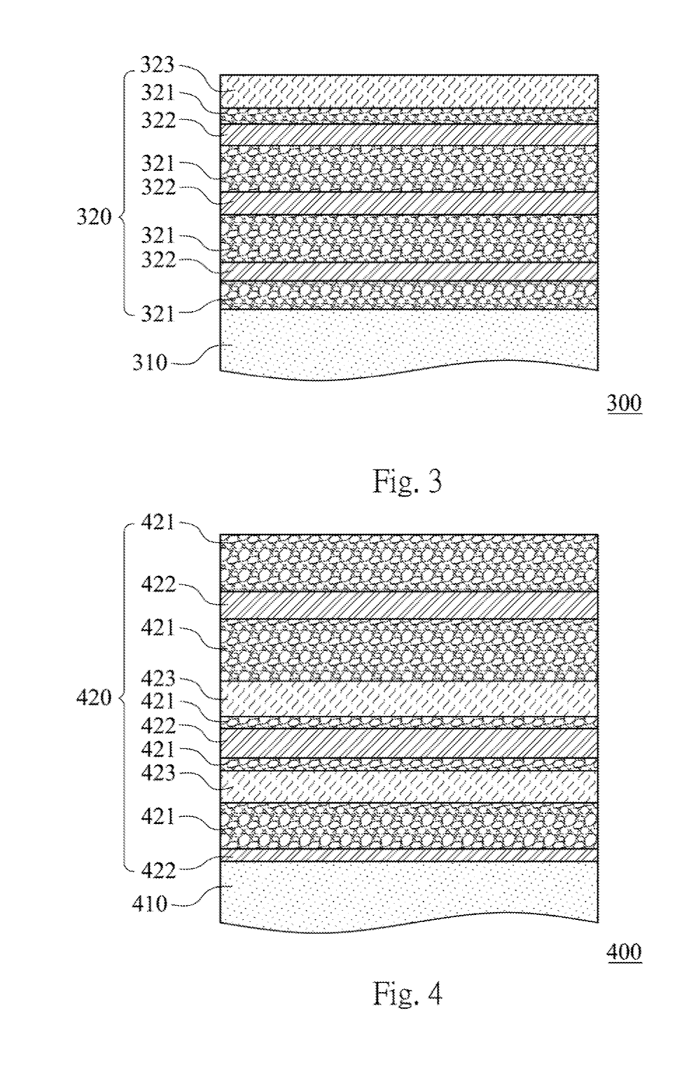

FIG. 3 is a schematic view of an infrared filter 300 according to the 3rd embodiment of the present disclosure. In FIG. 3, the infrared filter 300 includes a transparent substrate 310, and an infrared-filtering multilayer film 320. The infrared-filtering multilayer film 320 includes four first dielectric layers 321, three silver layers 322 and one second dielectric layer 323, wherein the four first dielectric layers 321 and the three silver layers 322 are alternately stacked. The second dielectric layer 323 is not adjacent to the silver layers 322, and one of the first dielectric layers 321 of the infrared-filtering multilayer film 320 is directly coated on the transparent substrate 310. More specifically, the second dielectric layer 323 is coated between air and one first dielectric layer 321.

In the 3rd embodiment, the first dielectric layers 321 are made of metallic or metalloid nitrides, such as, SiN, AlN or GaN. The first dielectric layers 321 may also be made of AlN, GaN, or other silicon nitrides with varying silicon oxidation states (SiₓN_{y}). The second dielectric layers 323 may be made of SiO₂, but are not limited thereto. Furthermore, the first dielectric layers 321 may also be made of Si_{X}N_{Y}, and the second dielectric layers 323 may also be made of Nb₂O₅, Ta₂O₅, ZrO₂, Y₂O₃, CeO₂, Al₂O₃, ZnO or titanium oxides (TiₓO_{y}),

In FIG. 3, each layer of the infrared-filtering multilayer film 320 is numbered 1 to 8 in ascending order, starting from the layer closest to the transparent substrate 310 to the layer closest to air. The material and the thickness of each layer in the infrared-filtering multilayer film 320 are shown in Table 5. Moreover, the decay rate and the transmittance responsivity value of the infrared filter 300 at two different chief ray angles (0° and 40°) are shown in Table 6.

TABLE 5

| | | Thickness | | Thickness | | Thickness | | |
|---|---|---|---|---|---|---|---|---|
| No. | Material | (nm) | Material | (nm) | Material | (nm) | Type of layer | |
| 8 | SiO₂ | 50.0 | SiO₂ | 50.0 | SiO₂ | 50.0 | second dielectric | 323 |
| | | | | | | | layer | |
| 7 | SiN | 12.4 | AlN | 11.0 | GaN | 13.7 | first dielectric layer | 321 |
| 6 | Ag | 16.2 | Ag | 15.4 | Ag | 18.0 | silver layer | 322 |
| 5 | SiN | 70.4 | AlN | 68.4 | GaN | 55.4 | first dielectric layer | 321 |
| 4 | Ag | 17.8 | Ag | 16.5 | Ag | 18.3 | silver layer | 322 |
| 3 | SiN | 71.6 | AlN | 70.1 | GaN | 57.2 | first dielectric layer | 321 |
| 2 | Ag | 14.4 | Ag | 13.7 | Ag | 16.9 | silver layer | 322 |
| 1 | SiN | 33.7 | AlN | 32.8 | GaN | 27.8 | first dielectric layer | 321 |

TABLE 6

| First dielectric | Chief Ray | Blue | Green | Red |
|---|---|---|---|---|
| layer 321 | Angles (deg.) | Light | Light | Light |
| | | Transmittance Responsivity Value | | |
| SiN | 0 | 81.18 | 90.91 | 62.88 |
| | 40 | 80.45 | 88.41 | 53.27 |
| | | Decay Rate (%) | | |
| | | 0.90 | 2.75 | 15.28 |
| AlN | 0 | 78.83 | 89.98 | 62.93 |
| | 40 | 77.71 | 87.47 | 53.62 |
| | | Decay Rate (%) | | |
| | | 1.42 | 2.79 | 14.79 |
| GaN | 0 | 81.93 | 91.39 | 62.28 |
| | 40 | 80.79 | 89.13 | 55.40 |

| Decay Rate (%) | | |
|---|---|---|
| 1.39 | 2.47 | 11.05 |

In Table 5, the total thickness of the infrared-filtering multilayer film 320 of the infrared filter 300 having the first dielectric layers made of SiN is 286.5 nm, the total thickness of the infrared-filtering multilayer film 320 of the infrared filter 300 having the first dielectric layers made of AlN is 277.9 nm, and the total thickness of the infrared-filtering multilayer film 320 of the infrared filter 300 having the first dielectric layers made of GaN is 257.3 nm.

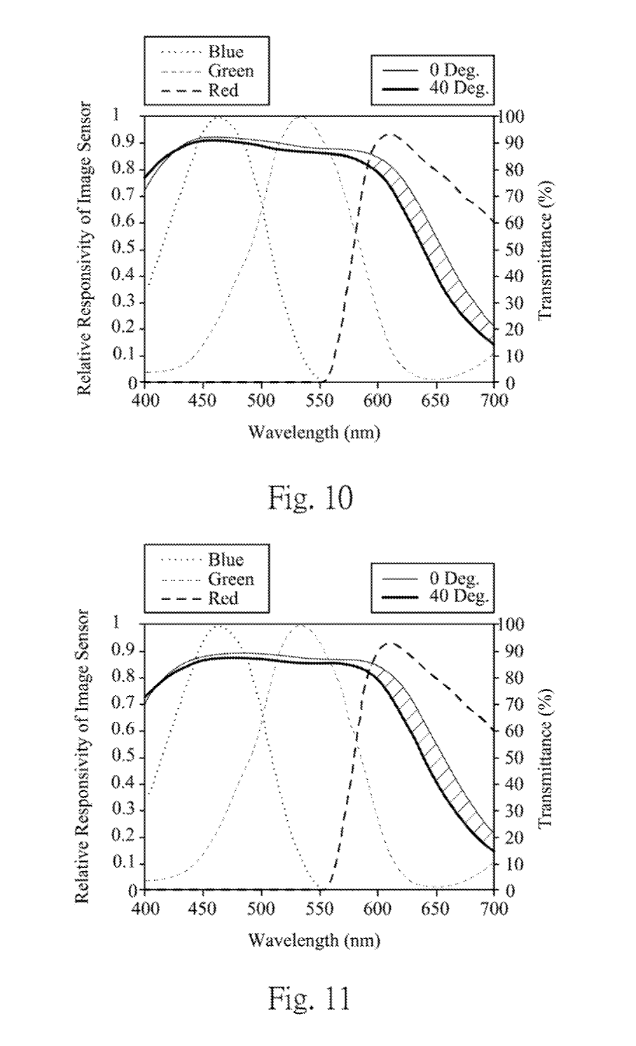

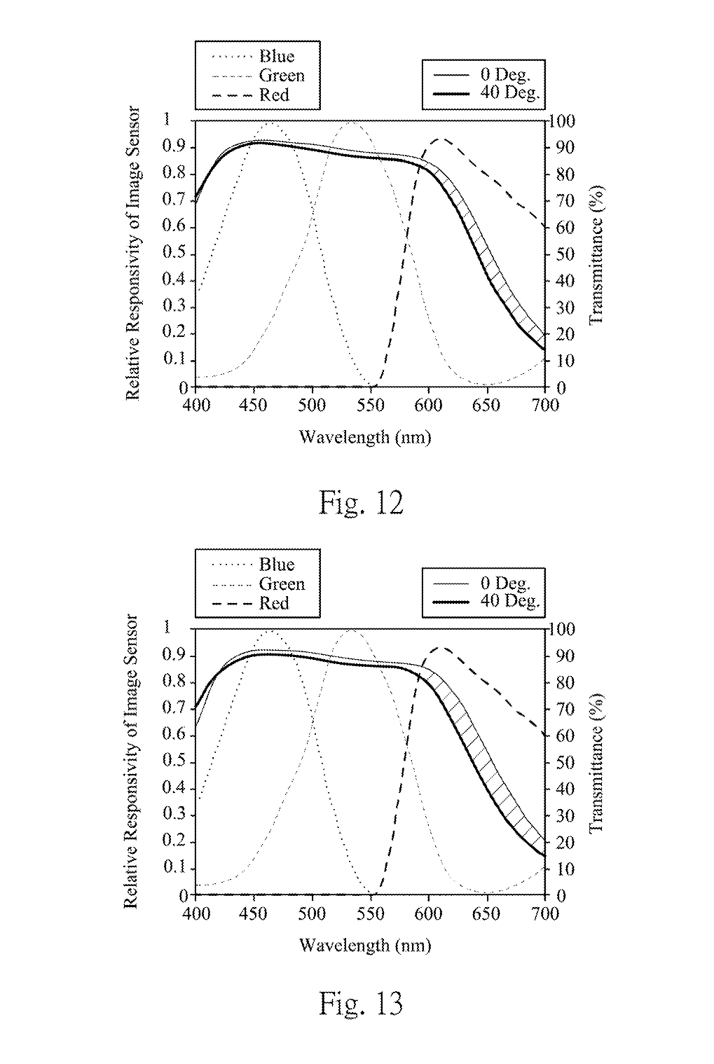

FIG. 10 to FIG. 12 together show a transmittance and relative responsivity spectrum of the infrared filter 300 having the first dielectric layers 321 made of SiN, of the infrared filter 300 having the first dielectric layers 321 made of AlN, and of the infrared filter 300 having the first dielectric layers 321 made of GaN, respectively according to the 3rd embodiment of the present disclosure. In FIG. 10 to FIG. 12, the hatched region represents the difference in the transmittance responsivity values (within the wavelength range of 554 nm to 700 nm) between chief ray angles of 0 degrees and 40 degrees.

### 4th Embodiment

FIG. 4 is a schematic view of an infrared filter 400 according to the 4th embodiment of the present disclosure. In FIG. 4, the infrared filter 400 includes a transparent substrate 410, and an infrared-filtering multilayer film 420. The infrared-filtering multilayer film 420 includes five first dielectric layers 421, three silver layers 422 and two second dielectric layers 423, wherein the five first dielectric layers 421 and the three silver layers 422 are alternately stacked. The second dielectric layers 423 are not adjacent to the silver layers 422, and one of the silver layers 422 of the infrared-filtering multilayer film 420 is directly coated on the transparent substrate 410. More specifically, the second dielectric layer 423 is coated between any two of the first dielectric layers 421.

In the 4th embodiment, the first dielectric layers 421 are made of SiN. The second dielectric layers 423 are made of Nb₂O₅, but are not limited thereto. Furthermore, the first dielectric layers 421 may also be made of AlN, GaN, or other silicon nitrides with varying silicon oxidation states (SiₓN_{y}). The second dielectric layers 423 may also be made of Ta₂O₅, ZrO₂, Y₂O₃, CeO₂, Al₂O₃, ZnO, SiO₂ or titanium oxides (Ti₃O_{y}).

In FIG. 4, each layer of the infrared-filtering multilayer film 420 is numbered 1 to 10 in ascending order, starting from the layer closest to the transparent substrate 410 to the layer closest to air. The material and the thickness of each layer in the infrared-filtering multilayer film 420 are shown in Table 7. Moreover, the decay rate and the transmittance responsivity value of the infrared filter 400 at two different chief ray angles (0° and 40°) are shown in Table 8.

TABLE 7

| No. | Material | Thickness (nm) | Type of layer | |
|---|---|---|---|---|
| 10 | SiN | 35.7 | first dielectric layer | 421 |
| 9 | Ag | 18.7 | silver layer | 422 |
| 8 | SiN | 38.5 | first dielectric layer | 421 |
| 7 | Nb₂O₅ | 22.4 | second dielectric layer | 423 |
| 6 | SiN | 7.4 | first dielectric layer | 421 |
| 5 | Ag | 18.8 | silver layer | 422 |
| 4 | SiN | 7.8 | first dielectric layer | 421 |
| 3 | Nb₂O₅ | 20.8 | second dielectric layer | 423 |
| 2 | SiN | 28.8 | first dielectric layer | 421 |
| 1 | Ag | 8.2 | silver layer | 422 |

TABLE 8

| First dielectric | Chief Ray | Blue | Green | Red |
|---|---|---|---|---|
| layer 421 | Angles (deg.) | Light | Light | Light |
| | | Transmittance Responsivity Value | | |
| SiN | 0 | 81.31 | 91.39 | 62.81 |
| | 40 | 80.12 | 88.91 | 53.53 |

| Decay Rate (%) | | |
|---|---|---|
| 1.46 | 2.71 | 14.77 |

In Table 7, a total thickness of the infrared-filtering multilayer film 420 of the IR filter 400 is 207.1 nm. FIG. 13 together shows a transmittance and relative responsivity spectrum of the infrared filter 400, and the hatched region represents the difference in the transmittance responsivity values (within the wavelength range of 554 nm to 700 nm) between chief ray angles of 0 degrees and 40 degrees.

### 5th Embodiment

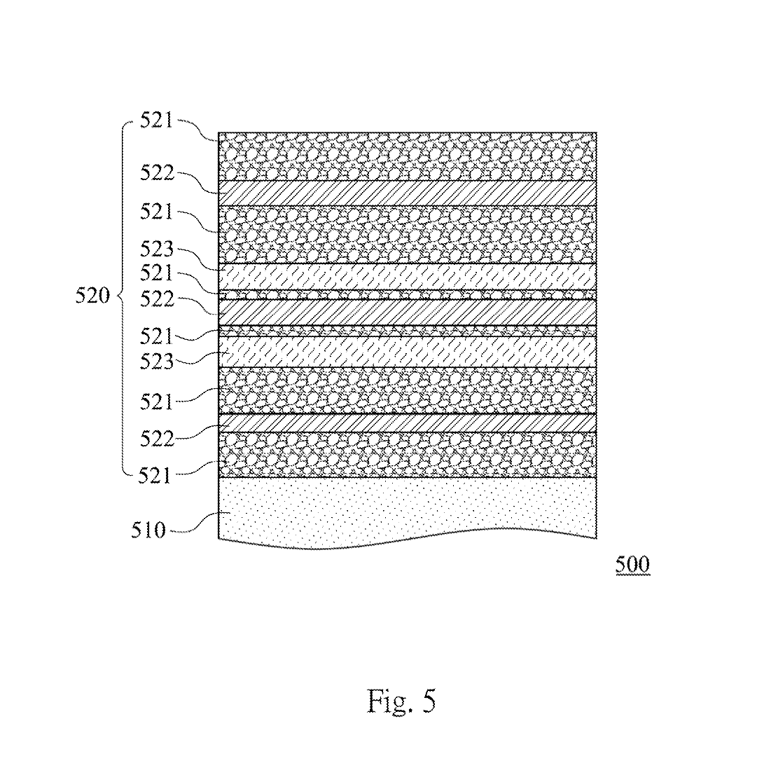

FIG. 5 is a schematic view of an infrared filter 500 according to the 5th embodiment of the present disclosure. In FIG. 5, the infrared filter 500 includes a transparent substrate 510, and an infrared-filtering multilayer film 520. The infrared-filtering multilayer film 520 includes six first dielectric layers 521, three silver layers 522 and two second dielectric layers 523, wherein the six first dielectric layers 521 and the three silver layers 522 are alternately stacked. The second dielectric layers 523 are not adjacent to the silver layers 522, and one of the first dielectric layers 521 of the infrared-filtering multilayer film 520 is directly coated on the transparent substrate 510. More specifically, the second dielectric layer 523 is coated between any two of the first dielectric layers 521.

In the 5th embodiment, the first dielectric layers 521 are made of SiN. The second dielectric layers 523 are made of Nb₂O₅, but are not limited thereto. Furthermore, the first dielectric layers 521 may also be made of AlN, GaN, or other silicon nitrides with varying silicon oxidation states (SiₓN_{y}). The second dielectric layers 523 may also be made of Ta₂O₅, ZrO₂, Y₂O₃CeO₂, Al₂O₃, ZnO, SiO₂ or titanium oxides (TiₓO_{y}).

In FIG. 5, each layer of the infrared-filtering multilayer film 520 is numbered 1 to 11 in ascending order, starting from the layer closest to the transparent substrate 510 to the layer closest to air. The material and the thickness of each layer in the infrared-filtering multilayer film 520 are shown in Table 9. Moreover, the decay rate and the transmittance responsivity value of the IR filter 500 at two different chief ray angles (0° and 40°) are shown in Table 10.

TABLE 9

| No. | Material | Thickness (nm) | Type of layer | |
|---|---|---|---|---|
| 11 | SiN | 35.9 | first dielectric layer | 521 |
| 10 | Ag | 18.5 | silver layer | 522 |
| 9 | SiN | 42.6 | first dielectric layer | 521 |
| 8 | Nb₂O₅ | 19.5 | second dielectric layer | 523 |
| 7 | SiN | 7.1 | first dielectric layer | 521 |
| 6 | Ag | 19.2 | silver layer | 522 |
| 5 | SiN | 8.2 | first dielectric layer | 521 |
| 4 | Nb₂O₅ | 22.5 | second dielectric layer | 523 |
| 3 | SiN | 34.8 | first dielectric layer | 521 |
| 2 | Ag | 13.2 | silver layer | 522 |
| 1 | SiN | 33.4 | first dielectric layer | 521 |

TABLE 10

| First dielectric | Chief Ray | Blue | Green | Red |
|---|---|---|---|---|
| layer 521 | Angles (deg.) | Light | Light | Light |
| | | Transmittance Responsivity Value | | |
| SiN | 0 | 81.78 | 91.36 | 62.88 |
| | 40 | 80.35 | 88.68 | 53.59 |

| Decay Rate (%) | | |
|---|---|---|
| 1.75 | 2.93 | 14.77 |

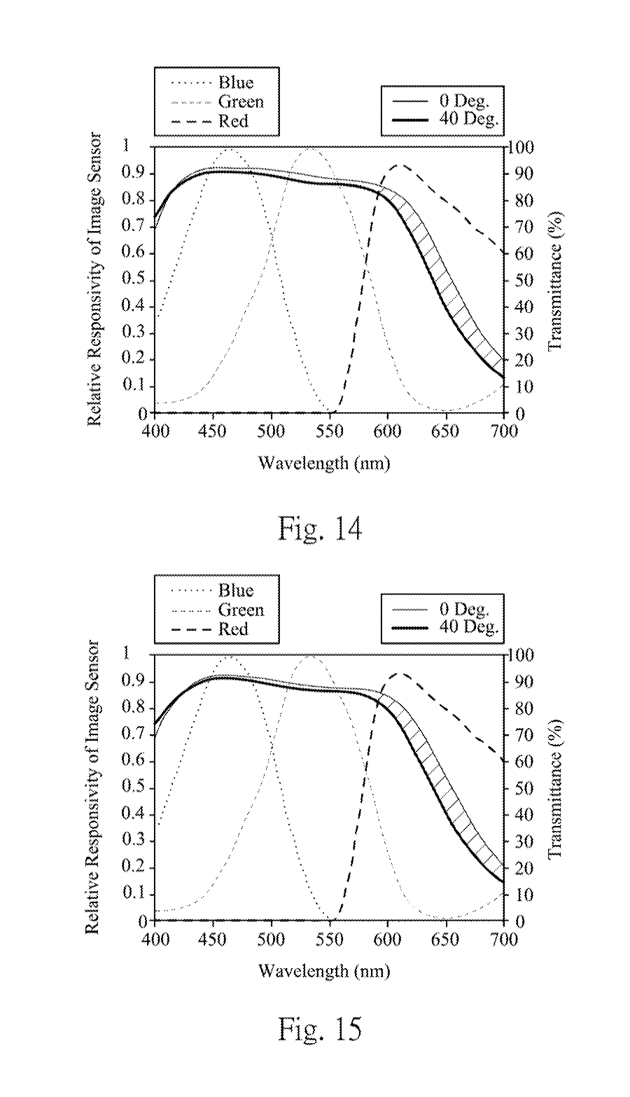

In Table 9, a total thickness of the infrared-filtering multilayer film 520 of the IR filter 500 is 254.9 nm. FIG. 14 together shows a transmittance and relative responsivity spectrum of the infrared filter 500, and the hatched region represents the difference in the transmittance responsivity values (within the wavelength range of 554 nm to 700 nm) between chief ray angles of 0 degrees and 40 degrees.

6th Embodiment

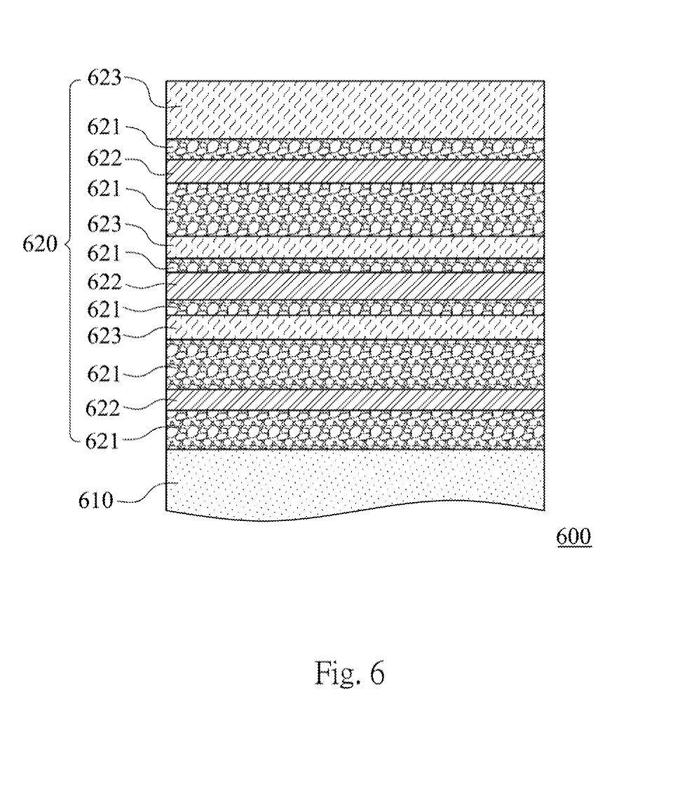

FIG. 6 is a schematic view of an infrared filter 600 according to the 6th embodiment of the present disclosure. In FIG. 6, the infrared filter 600 includes a transparent substrate 610, and an infrared-filtering multilayer film 620. The infrared-filtering multilayer film 620 includes six first dielectric layers 621, three silver layers 622 and three second dielectric layers 623, wherein the six first dielectric layers 621 and the three silver layers 622 are alternately stacked. The second dielectric layers 623 are not adjacent to the silver layers 622, and one of the first dielectric layers 621 of the infrared-filtering multilayer film 620 is directly coated on the transparent substrate 610.

More specifically, one of the second dielectric layers 623 is coated between air and one first dielectric layer 621, and the other two second dielectric layers 623 are coated between any two of the first dielectric layers 621 respectively. The material for making the second dielectric layer 623 coated between air and the first dielectric layer 621 is different from those for making the other two second dielectric layers 623 coated between any two of the first dielectric layers 621.

In the 6th embodiment, the first dielectric layers 621 are made of SiN. The second dielectric layer 623 coated between air and the first dielectric layer 621 is made of SiO₂. However, the other second dielectric layers 623 coated between any two of the first dielectric layers 621 are both made of Nb₂O₅, but are not limited thereto. Furthermore, the first dielectric layers 621 may also be made of AlN, GaN, or other silicon nitrides with varying silicon oxidation states (SiₓN_{y}). The second dielectric layers 623 may also be made of Ta₂O₅, ZrO₂, Y₂O₃, CeO₂, Al₂O₃, ZnO, SiO₂ or titanium oxides (TiₓO_{y}).

In FIG. 6, each layer of the infrared-filtering multilayer film 620 is numbered 1 to 12 in ascending order, starting from the layer closest to the transparent substrate 610 to the layer closest to air. The material and the thickness of each layer in the infrared-filtering multilayer film 620 are shown in Table 11. Moreover, the decay rate and the transmittance responsivity value of the IR filter 600 at two different chief ray angles (0° and 40°) are shown in Table 12.

TABLE 11

| No. | Material | Thickness (nm) | Type of layer | |
|---|---|---|---|---|
| 12 | SiO₂ | 50.0 | second dielectric layer | 623 |
| 11 | SiN | 13.3 | first dielectric layer | 621 |
| 10 | Ag | 15.8 | silver layer | 622 |
| 9 | SiN | 46.6 | first dielectric layer | 621 |
| 8 | Nb₂O₅ | 14.2 | second dielectric layer | 623 |
| 7 | SiN | 7.1 | first dielectric layer | 621 |
| 6 | Ag | 19.0 | silver layer | 622 |
| 5 | SiN | 8.2 | first dielectric layer | 621 |
| 4 | Nb₂O₅ | 16.7 | second dielectric layer | 623 |
| 3 | SiN | 43.0 | first dielectric layer | 621 |
| 2 | Ag | 13.8 | silver layer | 622 |
| 1 | SiN | 34.0 | first dielectric layer | 621 |

TABLE 12

| First dielectric | Chief Ray | Blue | Green | Red |
|---|---|---|---|---|
| layer 621 | Angles (deg.) | Light | Light | Light |
| | | Transmittance Responsivity Value | | |
| SiN | 0 | 81.16 | 80.99 | 62.69 |
| | 40 | 80.40 | 88.71 | 53.83 |

| Decay Rate (%) | | |
|---|---|---|
| 0.94 | 2.50 | 14.13 |

In Table 11, a total thickness of the infrared-filtering multilayer film 620 of the IR filter 600 is 281.7 nm. FIG. 15 together shows a transmittance and relative responsivity spectrum of the infrared filter 600, and the hatched region represents the difference in the transmittance responsivity values (within the wavelength range of 554 nm to 700 nm) between chief ray angles of 0 degrees and 40 degrees.

### 7th Embodiment

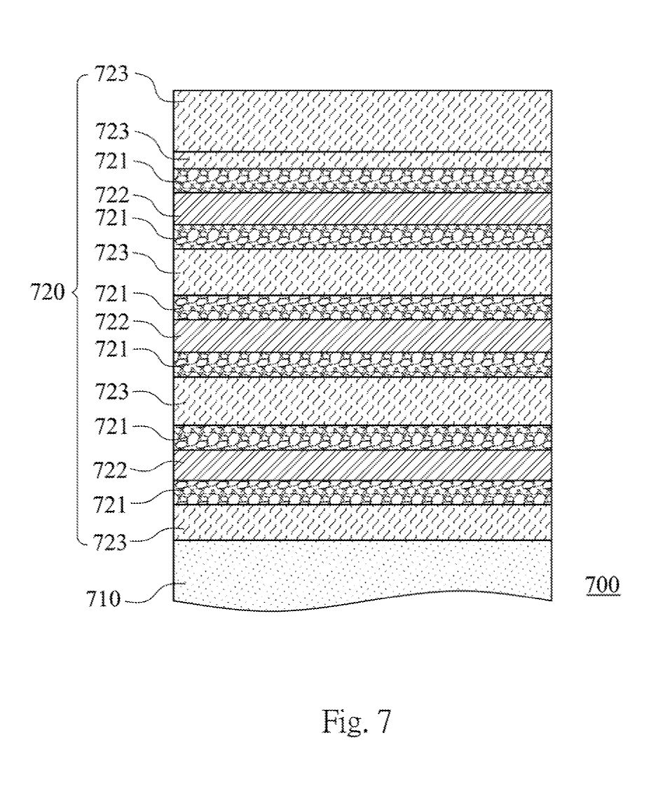

FIG. 7 is a schematic view of an infrared filter 700 according to the 7th embodiment of the present disclosure. In FIG. 7, the infrared filter 700 includes a transparent substrate 710, and an infrared-filtering multilayer film 720. The infrared-filtering multilayer film 720 includes six first dielectric layers 721, three silver layers 722 and five second dielectric layers 723, wherein the six first dielectric layers 721 and the three silver layers 722 are alternately stacked. The second dielectric layers 723 are not adjacent to the silver layers 722, and one of the second dielectric layers 723 of the infrared-filtering multilayer film 720 is directly coated on the transparent substrate 710.

More specifically, one of the second dielectric layers 723 is coated between the transparent substrate 710 and the first dielectric layer 721. Another two of the second dielectric layers 723 are stacked together and coated between air and the first dielectric layer 721 wherein these two second dielectric layers 723 are made of different materials. The other two of the second dielectric layers 723 are coated between any two of the first dielectric layers 721 respectively.

In the 7th embodiment, the first dielectric layers 721 are made of Sill. The second dielectric layer 723 coated closest to air and furthest from the transparent substrate 710 is made of SiO₂. The other four second dielectric layers 723 are all made of Nb₂O₅, but are not limited thereto. Furthermore, the first dielectric layers 721 may also be made of AIN, GaN, or other silicon nitrides with varying silicon oxidation states (SiₓN_{y}). The second dielectric layers 723 may also be made of Ta₂O₅, ZrO₂, Y₂O₃, CeO₂, Al₂O₃, ZnO, SiO₂ or titanium oxides (TiₓO_{y}).

In FIG. 7, each layer of the infrared-filtering multilayer film 720 is numbered 1 to 14 in ascending order, starting from the layer closest to the transparent substrate 710 to the layer closest to air. The material and the thickness of each layer in the infrared-filtering multilayer film 720 are shown in Table 13. Moreover, the decay rate and the transmittance responsivity value of the IR filter 700 at two different chief ray angles (0° and 40°) are shown in Table 14,

TABLE 13

| No. | Material | Thickness (nm) | Type of layer | |
|---|---|---|---|---|
| 14 | SiO₂ | 50.0 | second dielectric layer | 723 |
| 13 | Nb₂O₅ | 4.1 | second dielectric layer | 723 |
| 12 | SiN | 10.0 | first dielectric layer | 721 |
| 11 | Ag | 16.5 | silver layer | 722 |
| 10 | SiN | 10.0 | first dielectric layer | 721 |
| 9 | Nb₂O₅ | 38.9 | second dielectric layer | 723 |
| 8 | SiN | 10.0 | first dielectric layer | 721 |
| 7 | Ag | 17.0 | silver layer | 722 |
| 6 | SiN | 10.0 | first dielectric layer | 721 |
| 5 | Nb₂O₅ | 40.7 | second dielectric layer | 723 |
| 4 | SiN | 10.0 | first dielectric layer | 721 |
| 3 | Ag | 15.4 | silver layer | 722 |
| 2 | SiN | 10.0 | first dielectric layer | 721 |
| 1 | Nb₂O₅ | 19.4 | second dielectric layer | 723 |

TABLE 14

| First dielectric | Chief Ray | Blue | Green | Red |
|---|---|---|---|---|
| layer 721 | Angles (deg.) | Light | Light | Light |
| | | Transmittance Responsivity Value | | |
| SiN | 0 | 81.22 | 91.30 | 62.50 |
| | 40 | 80.59 | 89.13 | 54.81 |

| Decay Rate (%) | | |
|---|---|---|
| 0.78 | 2.38 | 12.30 |

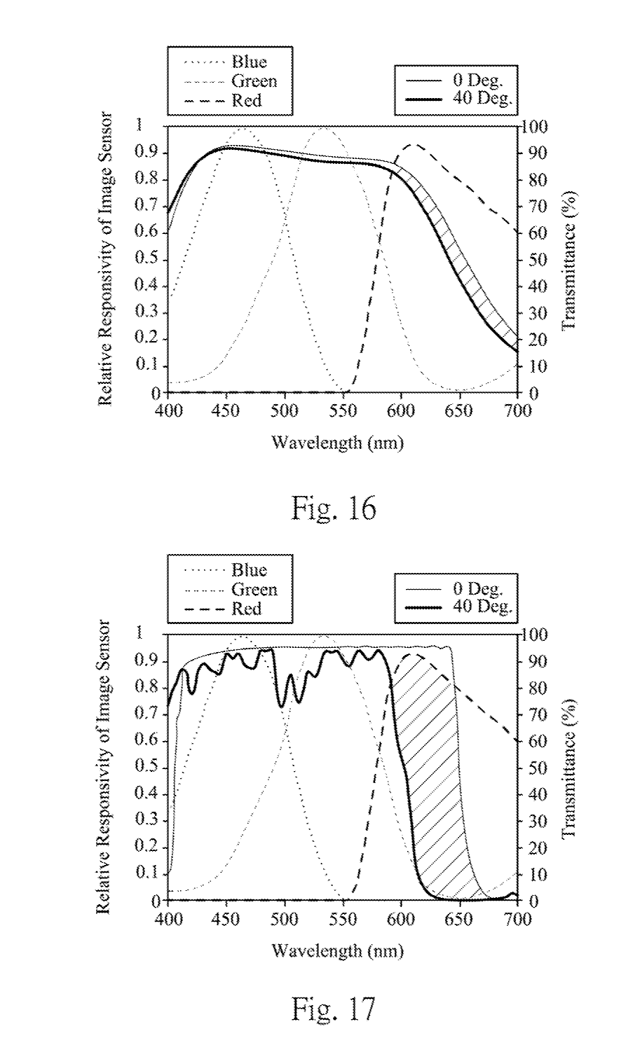

In Table 13, a total thickness of the infrared-filtering multilayer film 720 of the IR filter 700 is 262 nm. FIG. 16 together shows a transmittance and relative responsivity spectrum of the infrared filter 700, and the hatched region represents the difference in the transmittance responsivity values (within the wavelength range of 554 nm to 700 nm) between chief ray angles of 0 degrees and 40 degrees.

According to the embodiments of the present disclosure, the infrared-filtering multilayer film may be a stack of multiple repeating units, and the number of the repeating units can be adjusted. Taking the 1st embodiment as an example, the entire arrangement from the layer closest to the transparent substrate (No. 1) to the layer closest to air (No. 6) can be defined as one repeating unit using the aforementioned definition. When the infrared-filtering multilayer film is a stack of seven repeating units, the total number of layers in icy the infrared-filtering multilayer film is 42, and the total number of the silver layers is 21. Likewise the number of the repeating units of the infrared-filtering multilayer film in the aforementioned second to seventh embodiments also can be adjusted.

### Comparative Example

An exemplified infrared filter is a transparent substrate with two differ kinds of dielectric layers alternately stacked and coated on the transparent substrate, wherein the total number of layers of the stack is 44. Furthermore, the material and the thickness of each layer of the exemplified infrared filter, numbered 1 to 44 in ascending order, starting from the layer closest to the transparent substrate to the layer closest to air are shown in Table 15. The decay rate and the transmittance responsivity value of the exemplified infrared filter at two different chief ray angles (0 and 40°) are shown in Table 16.

TABLE 15

| No. | Material | Thickness (nm) |
|---|---|---|
| 44 | SiO₂ | 79.3 |
| 43 | TiO₂ | 102.2 |
| 42 | SiO₂ | 10.5 |
| 41 | TiO₂ | 98.5 |
| 40 | SiO₂ | 152.2 |
| 39 | TiO₂ | 72.6 |
| 38 | SiO₂ | 146.8 |
| 37 | TiO₂ | 66.7 |
| 36 | SiO₂ | 150.7 |
| 35 | TiO₂ | 61.6 |
| 34 | SiO₂ | 155.5 |
| 33 | TiO₂ | 58.7 |
| 32 | SiO₂ | 156.9 |
| 31 | TiO₂ | 59.9 |
| 30 | SiO₂ | 153.9 |
| 29 | TiO₂ | 65.2 |
| 28 | SiO₂ | 149.9 |
| 27 | TiO₂ | 76.8 |
| 26 | SiO₂ | 169.3 |
| 25 | TiO₂ | 113.9 |
| 24 | SiO₂ | 165.9 |
| 23 | TiO₂ | 78.5 |
| 22 | SiO₂ | 146.9 |
| 21 | TiO₂ | 74.9 |
| 20 | SiO₂ | 148.4 |
| 19 | TiO₂ | 80.5 |
| 18 | SiO₂ | 166.8 |
| 17 | TiO₂ | 113.7 |
| 16 | SiO₂ | 188.4 |
| 15 | TiO₂ | 112.8 |
| 14 | SiO₂ | 190.5 |
| 13 | TiO₂ | 111.1 |
| 12 | SiO₂ | 179.8 |
| 11 | TiO₂ | 103.9 |
| 10 | SiO₂ | 172.9 |
| 9 | TiO₂ | 106.9 |
| 8 | SiO₂ | 185.1 |
| 7 | TiO₂ | 112.5 |
| 6 | SiO₂ | 186.2 |
| 5 | TiO₂ | 112.6 |
| 4 | SiO₂ | 181.9 |
| 3 | TiO₂ | 110.8 |
| 2 | SiO₂ | 39.4 |
| 1 | TiO₂ | 10.1 |

TABLE 16

| Dielectric | Chief Ray | Blue | Green | Red |
|---|---|---|---|---|
| Layer | Angles (deg.) | Light | Light | Light |
| | | Transmittance Responsivity Value | | |
| TiO₂ + SiO₂ | 0 | 83.33 | 97.20 | 63.93 |
| | 40 | 79.04 | 87.29 | 22.52 |

| Decay Rate (%) | | |
|---|---|---|
| 5.15 | 10.20 | 64.77 |

In Table 15, a total thickness of the exemplified infrared filter is 5181.6 nm. FIG. 17 together shows a transmittance and relative responsivity spectrum of the exemplified infrared filter, and the hatched region represents the difference in the transmittance responsivity values (within the wavelength range of 554 nm to 700 nm) between chief ray angles of 0 degrees and 40 degrees.

In Table 16 and FIG. 17, when the exemplified infrared filter is at chief ray angles of 0° and 40°, the decay rates of the blue light and green light are about 5% and 10% respectively, and the red light is as high as around 65% (especially between 554 nm and 700 nm). Nevertheless, the decay rates of the infrared filter of every embodiment in this present disclosure are not that high under the same test condition. The decay rates of the blue light and the green light are only around 0.78% to 1.75% and 2.38% to 3.29% respectively, and the decay rate of the red light is even only around 11% to 16%. Accordingly, the infrared filter of the present disclosure is favorable for effectively improving the color shift in the peripheral region of the image.

The foregoing description, for purpose of explanation, has been described with reference to specific embodiments. It is to be noted that TABLES 1-14 show different data of the different embodiments; however, the data of the different embodiments are obtained from experiments. The embodiments ere chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An infrared filter comprising
a transparent substrate; and
an infrared-filtering multilayer film, wherein the infrared-filtering multilayer film is coated on the transparent substrate, and the infrared-filtering multilayer film comprises:
a plurality of first dielectric layers, and
a plurality of silver layers;
wherein the first dielectric layers and the silver layers are alternately stacked, and the first dielectric layers are made of nitride;
wherein a total number of layers in the infrared-filtering multilayer film is TL, a total thickness of the infrared-filtering multilayer film is TT, a total number of the silver layers is AgL, and the following conditions are satisfied:
6≦TL≦42;
100 nm≦TT≦4000 nm; and
3≦AgL≦21.

2. The infrared filter of claim 1, wherein the nitride of the first dielectric layers is silicon nitride, a total number of the first dielectric layers is DLA, and the following condition is satisfied:
3≦DLA.

3. The infrared filter of claim 2, wherein the infrared-filtering multilayer film further comprises:
at least one second dielectric layer made of metal oxide, wherein at least one of the first dielectric layers is coated between the second dielectric layer and one of the silver layers, the total number of the first dielectric layers is DLA, a total number of the second dielectric layer is DLB, and the following conditions are satisfied:
5≦DLA; and
1≦DLB.

4. The infrared filter of claim 3, wherein the transparent substrate is made of plastics.

5. The infrared filter of claim 2, wherein the total thickness of the infrared-filtering multilayer film is TT, and the following condition is satisfied:
100 nm≦TT≦2000 nm.

6. The infrared filter of claim 2, wherein a decay rate of a transmittance responsivity value through the infrared filter between 554 nm and 700 nm is D, and the following condition is satisfied:
1%≦D≦30%.

7. The infrared filter of claim 6, wherein the decay rate of the transmittance responsivity value through the infrared filter between 554 nm and 700 nm is D, and the following condition is satisfied:
1%≦D≦20%.

8. The infrared filter of claim 1, wherein the nitride of the first dielectric layers is AlN, a total number of the first dielectric layers is DLA, and the following conditions are satisfied:
3≦DLA.

9. The infrared filter of claim 8, herein the infrared-filtering multilayer film comprises:
at least one second dielectric layer made of metal oxide, wherein at least one of the first dielectric layers is coated between the second dielectric layer and one of the silver layers, a total number of the first dielectric layers is DLA, a total number of the second dielectric layer is DLB, and the following conditions are satisfied:
5≦DLA; and
1≦DLB.

10. The infrared filter of claim 9, wherein the transparent substrate is made of plastics.

11. The infrared filter of claim 8, wherein the total thickness of the infrared-filtering multilayer film is TT, and the following condition is satisfied:
100 nm≦TT≦2000 nm.

12. The infrared filter of claim 8, wherein a decay rate of the transmittance responsivity value through the infrared filter between 554 nm and 700 nm is D, and the following condition is satisfied:
1%≦D≦30%.

13. The infrared filter of claim 12, a decay rate of the transmittance responsivity value through the infrared filter between 554 nm and 700 nm is D, and the following condition is satisfied:
1%≦D≦20%.

14. The infrared filter of claim 1, wherein the nitride of the first dielectric layers is GaN, a total number of the first dielectric layers is DLA, and the following condition is satisfied:
3≦DLA.

15. The infrared filter of claim 14, wherein the infrared-filtering multilayer film comprises:
at least one second dielectric layer made of metal oxide, wherein at least one of the first dielectric layers is coated between the second dielectric layer and one of the silver layers, a total number of the first dielectric layers is DLA, a total number of the second dielectric layer is DLB, and the following conditions are satisfied:
5≦DLA; and
1≦DLB.

16. The infrared filter of claim 15, wherein the transparent substrate is made of plastics.

17. The infrared filter of claim 14, wherein the total thickness of the infrared-filtering multilayer film is TT, and the following condition is satisfied:
100 nm≦TT≦2000 nm.

18. The infrared filter of claim 14, wherein a decay rate of the transmittance responsivity value through the infrared filter between 554 nm and 700 nm is D, and the following condition is satisfied:
1%≦D≦30%

19. The infrared filter of claim 18, a decay rate of the transmittance responsivity value through the infrared filter between 554 nm and 700 nm is D, and the following condition is satisfied:
1%≦D≦20%.
